(19) United States
(12) Patent Application Publication
(10) Pub. No.: US 2004/0000062 A1
(43) Pub. Date: Jan. 1, 2004

(54) Compass display for a vehicle

(75) Inventors: Scott A. Hansen, Holland, MI (US); Nels R. Smith, Holland, MI (US); Robert F. Buege, Lowell, MI (US); Thomas R. Olson, Holland, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/186,362

(22) Filed: Jun. 28, 2002

(51) Int. Cl. G01C 17/20

(52) U.S. Cl. 33/348

(57) ABSTRACT

A compass display or a low cost construction includes a display coupled to compass sensing and calibration devices to illuminate a portion of the display to indicate a specific heading. The display is mounted beneath a finish covering surface and includes indicia representing compass directional headings attached or printed thereon and the finish covering is supported by a substrate having a plurality of openings spaced relative to a center point and a plurality of light sources such as LED lights located in the holes of the substrate to be located behind the finish covering and aligned with the directional headings. When a light is illuminated, it is visible behind the finish covering to a driver or other occupant of the vehicle. In a preferred embodiment, twelve openings and associated light sources are provided in the substrate and spaced at 30-degree increments to provide a more precise indication of the vehicle heading. The compass display may be located on the instrument panel, in the headliner, on the A-pillar, on a visor or in any other advantageous location within the passenger compartment. For a movable object like the visor location, a switch is provided to disconnect a power source for the compass display when the visor is moved from its stowed, operating position.

### FIELD OF THE INVENTION

The present invention relates generally to the field of displays and more particularly to a low cost, convenient compass display for a passenger compartment in a vehicle.

### BACKGROUND OF THE INVENTION

A large number of vehicle compass devices and related compass displays are known. Two illustrative examples are shown and described in U.S. Pat. No. 4,953,305 issued Sep. 4, 1990 to Van Lente, et al., for Vehicle Compass With Automatic Continuous Calibration and in U.S. Pat. No. 5,878,370 issued Mar. 2, 1999 to Olson for Vehicle Compass System With Variable Resolution. The compass display disclosed herein is suitable for use with a variety of compass systems, including those using magneto-resistive, magneto-inductive, or other sensing technologies and compass systems configured to operate various automatic and/or continuous calibration algorithms, including those disclosed in the '305 Patent and the '370 Patent, U.S. Pat. Nos. 5,511,319, 5,664,335, 5,737,226, 5,761,094, 6,047,327, and 6,301,794. Such compass products involve a display visible to the driver or other occupants of the vehicle through the instrument panel, on the vehicle overhead console, or in the vehicle rearview mirror. One type of known compass display uses a vacuum florescent display to provide a read out of the compass direction.

Other compass devices for vehicles are known which are non-electric and simply mount on the instrument panel or other convenient location. The latter type of compass displays tend to be less reliable than electronic compasses which have an automatic calibration capability and display the vehicle heading in a prompt and accurate fashion.

An obstacle to the inclusion of compasses in nearly all vehicles being manufactured today is cost. In particular, the total cost of the compass includes the cost of the compass sensing components, including microprocessor, application-specific integrated circuit (ASIC), sensors, as well as the cost of the compass display. Typically, complex circuitry is required for the sensing components and has been used as part of the display. The development of a low-cost compass display system, which could be incorporated in a wide range of vehicle types, and which would allow the accuracy of known compass systems without the inherent cost for the display portion would represent a significant advance in the art. Further, the development of a compass display that can be satisfactorily adapted to be installed in alternate locations within the vehicle would also represent a significant advance in the art.

### SUMMARY OF THE INVENTION

The present invention relates to a low cost compass display that is easy-to-manufacture and of particular use in a vehicle and which may employ, as the operative components of the compass device, known compass technology and includes low cost elements for displaying a referent direction. The compass display according to the present invention is located with respect to a finish covering on the vehicle interior, the finish covering is constructed to allow an illuminated light source to be perceived by a viewer through the finish covering. The light source is controlled by the known compass technology to indicate vehicle heading. The light source of the compass display is preferably a low cost indicator such as a light emitting diode (LED).

The compass display, in one embodiment, preferably includes a plurality of LED's positioned about the center of the compass to indicate a heading of the vehicle with respect to a North referent (or other referent if desired) based upon an input from a directional indicator of the known compass technology. Further, the finish covering is preferably a fabric, cloth or other suitable finish material and directional indicators or referent lines are printed, screened or otherwise marked on the finish covering and coordinated with the light source. The directional indicators preferably include at least referent lines representing the directions of North, South, East and West and more detailed directional indicators such as North-East, South-East, South-West and North-West. Preferably, each directional indicator on the finish covering has associated with it a separate LED.

A switch is preferably centrally or otherwise provided to allow a user to access additional compass functions such as calibration, zone setting or simply on/off features or any other usable feature. The switch is preferably co-located with the compass display at the center of the compass's directional indicators.

A feature of the present invention includes a low-cost compass display. Another feature of the present invention includes a compass display which may be easily located at a variety of vehicle interior locations. According to one exemplary embodiment, the cost of the compass display is reduced by using low-cost LEDs instead of a reconfigurable display, such as a vacuum-fluorescent display, liquid crystal display, or other more complex display technology. According to another exemplary embodiment, the cost of the compass display is reduced by using a simple LED-driver circuit instead of a display driver circuit for a reconfigurable display. For example, a vacuum-fluorescent display (VFD) requires a filament that glows in response to a pulsed power signal. The components required to provide this pulsed power signal add cost to the display. Further, automotive VFDs are required to operate over a range of voltages, such as 9-16 Volts. A 12-Volt regulator and several large electrolytic capacitors are required to meet this requirement, which adds further cost to the display.

A further feature of the present invention includes a compass display which may be used at a variety of vehicle interior locations such as a vehicle visor which display is preferably disconnected from a power source when the visor is moved from a stowed location. A still further feature of the present invention includes a vehicle compass display which may be used with a variety of vehicle coverings, including fabric, cloth, leather, vinyl or any other suitable finish covering. Another feature of the present invention is the provision of a compass display which is easy to manufacture, which is reliable and which provides information to the driver or other vehicle occupants in a convenient and accurate fashion.

How these and other features of the present invention are accomplished will be described in the following detailed description of the preferred embodiment, taken generally in conjunction with the Figures. Generally, however, the above features are provided by locating an LED display with respect to a finish covering of a portion of the vehicle interior, such as the visor, instrument panel, A pillar, overhead liner or other location. Preferably, the LED's are positioned in an opening in a substrate below the finish covering, and arranged to designate directional points about the compass. Preferably, a plurality of light sources includes eight light sources or LED's spaced around a central point of the compass. The light sources correspond to directional indicators designating North, East, South and West headings and the compass designations located there between, i.e., North-East, South-East, South-West and North-West. Any other combination of directions may be desirable.

Preferably, the LED display of the present invention is activated when the vehicle ignition is turned to the on position or when it is turned to the accessory position. Alternatively, a switch may be provided to be turned on at the option of the driver and to access other functions such as calibration and zone setting. The compass display of the present invention is preferably viewable by the vehicle operator and vehicle occupants, but may be positioned in any manner to be viewable by some or all occupants. In a further alternative embodiment, it is possible for the compass display to be used independently.

In a most preferred embodiment, the compass display of the present invention is located on a surface of a visor in front of the driver's position in an automobile and a power source for illuminating the light source in the visor is designed to turn off when the visor is moved from a normal stowed position, such as when the visor is moved to either a lowered position or moved to prevent sun from entering a side window. By turning off the compass when the visor is moved from the stowed position, calibration errors are reduced or eliminated such that the compass display and compass sensor may be combined in a unit and mounted within the movable visor.

Alternatives to the features of the invention will be apparent to those skilled in the art after reviewing the present application, such other ways falling within the scope of the present invention if they fall within the scope of the claims which follow.

### BRIEF DESCRIPTION OF THE DRAWINGS

FIG. 1 is a partial perspective view of an interior of a vehicle having a visor including a compass display according to the present invention.

FIG. 2 is a partial, perspective cross section view of the visor including the compass display according to the present invention taken along the line 8-8 of FIG. 1.

FIG. 3 is an alternate exploded assembly view of the visor of FIG. 1 including a compass display according to the present invention.

FIG. 4 is a partial perspective view of the visor of FIG. 1 showing a deactivation switch for the compass display according to the present invention.

FIG. 5 is a partial perspective view of a deactivation switch for the compass display of the present invention in a first position.

FIG. 6 is a partial perspective view of the visor of FIG. 1 showing the deactivation switch in a second position for the compass display of the present invention.

FIG. 7 is a partial perspective view of the deactivation switch in a second position for the compass display according to the present invention.

FIG. 8 is an exploded assembly perspective view of the visor of FIG. 1 including the compass display according to the present invention.

FIG. 9 is a perspective view of a visor for use in a vehicle, the visor including a compass display according to the present invention.

FIG. 10 is a partial perspective view of an interior of a vehicle having a headliner including the compass display according to the present invention.

FIG. 11 is a partial perspective view of an interior of a vehicle having a dash board including a compass display according to the present invention.

### DETAILED DESCRIPTION OF THE PREFERRED EMBODIMENTS

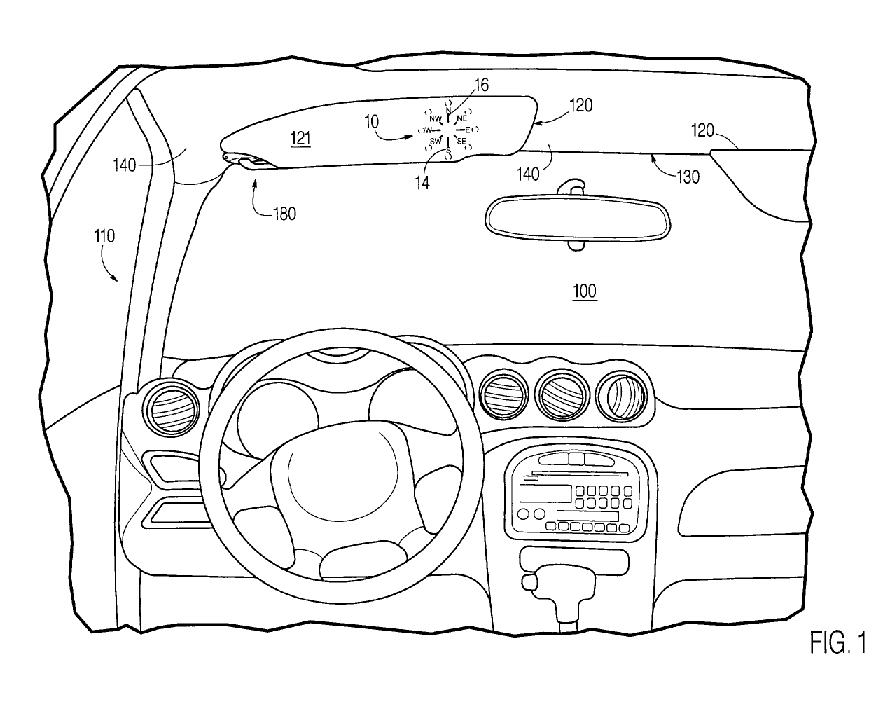

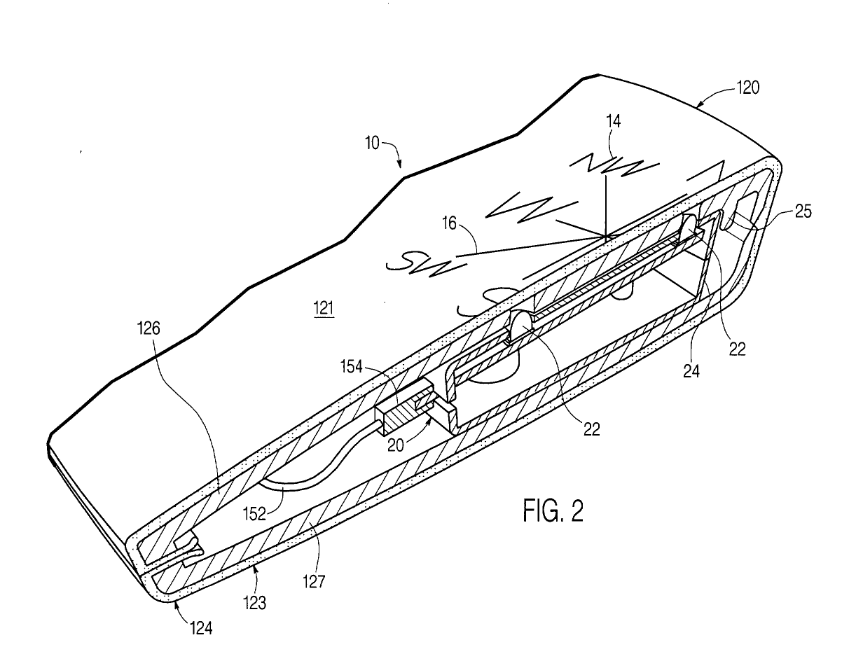

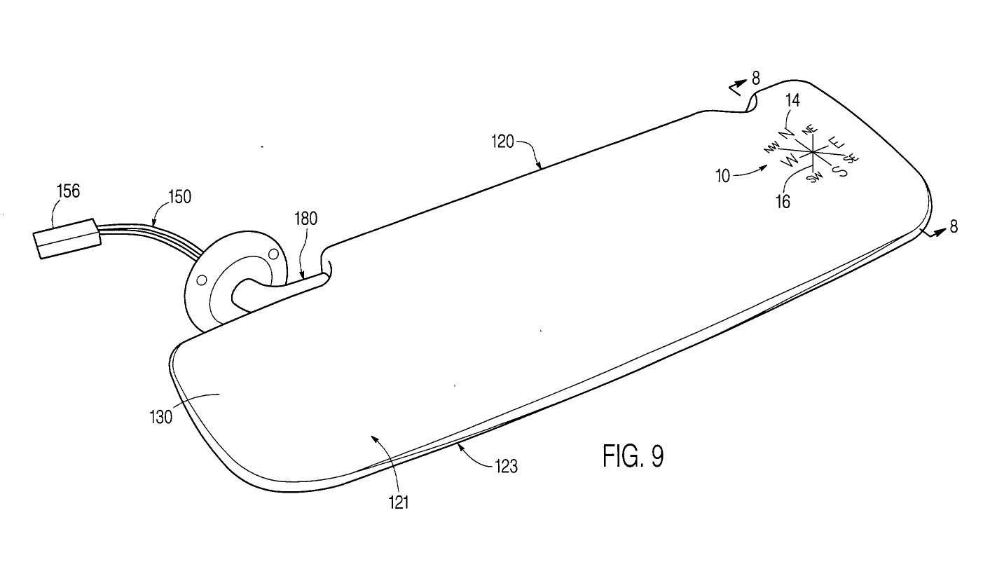

Referring generally to the figures and in particular to FIG. 1 and FIG. 2, there is shown a compass display 10 for use in a passenger compartment 100 of a vehicle 110. The compass display 10 relates to a compass assembly or unit 20 preferably installed in a visor 120 that is connected to a roof or headliner 140 of the vehicle 110. The visor 120 is preferably mounted to the headliner 140 using a pivot rod assembly 180 more fully described below or any other known or appropriate assembly for securing the visor 120 to the headliner 140. The visor 120 preferably includes a display or first side 121 which is viewable when the visor 120 is in a stowed position as shown in FIG. 9 and a second side 123 preferably opposite the first side 121.

The visor 120 is preferably constructed using any known or appropriate combination of materials and construction such as using the materials and a method similar to U.S. Pat. No. 5,860,690, the disclosure of which is incorporated herein by reference

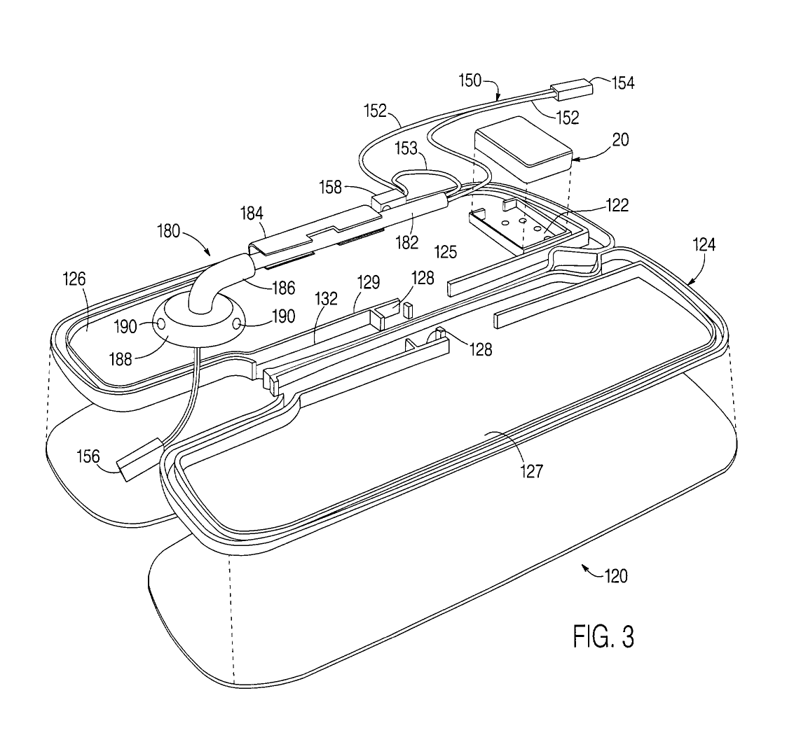

Referring to FIGS. 2 and 3, the compass unit 20 and display 10 are, in a preferred embodiment, incorporated into the visor 120 such that the display 10 is usable by the occupants of the vehicle to determine the heading of the vehicle with respect to a referent such as north. The compass unit 20 preferably includes the necessary electronics to generate a signal for indicating a heading such as those that are commonly used in vehicles.

The compass unit 20 can include magneto-resistive, magneto-inductive, or other sensors configured to measure the Earth's magnetic field. The compass unit 20 can further include a control or processing circuit configured to receive signals from the sensors (e.g., via an application-specific integrated circuit or ASIC) and to perform one or more automatic and/or continuous calibration algorithms. For example, the control circuit can be configured to operate one or more of the automatic continuous calibration methods disclosed in U.S. Pat. No. 4,953,305, which is herein incorporated by reference. Further, the control circuit can be configured to operate one or more of the automatic calibration methods disclosed in U.S. Pat. No. 5,737,226, which is herein incorporated by reference. Further still, the control circuit can be configured to vary the system's sensitivity resolution as disclosed in U.S. Pat. No. 5,878,370, which is herein incorporated by reference.

The compass unit 20 is located in a receptacle 122 formed in a core 124 of the visor 120 by a wall 125. The core 124 is preferably made from a thermoformed material and the wall 125 defining the space 122 is preferably integrally formed in the core 124 in any appropriate manner or fashion. However, the space 122 may be formed using any known material or process and in any alternative or appropriate form or shape to correspond to and hold the compass unit 20. The core 124 is preferably made from a thermoformed material more particularly, the core 124 is preferably formed from a thermoformed polypropylene material, which functions as a core of the visor 120. The core 124 is preferably formed into a first core portion 126 and a second core portion 127 which are separated by and can be folded along a fold line 128 which is preferably a living hinge in the middle portion of the core 124 such that the first core portion 126 and second core portion 127 are essentially mirror images of each other.

The compass unit 20 is preferably held in the space 122 between the layer portion 126 and layer portion 127 of the integrally formed layer 124 when the layer portions 126 and 127 are closed, the compass unit 20 is trapped between the layer portion 126 and 127 and by the wall 125. Alternatively, a connector (not pictured) may be used to clip or otherwise fasten and securely hold the compass unit 20 within the space 122 and allow the compass display 10 to be appropriately secured to and positioned in the interior structure of the visor 120. Other amenity items such as a mirror or mail holder (not shown) and the similar may also be added to the visor 120 as may be preferred for a given application. The wall 125 is shown as a projection from the layer portion 126 as being a continuous section having a break in one end. It should be understood that the wall 125 may have varying shapes and forms and may be continuous or discontinuous and may include additional elements provided the wall 125 holds the compass unit 20 in position between the partial layer 126 and partial layer 127.

The pivot rod 182 is also held in position between the first core portion 126 and second 127 similar to the compass unit 20. The pivot rod 182 of the pivot rod assembly 180 is received in a sleeve or carrier 184. The detent spring 184 functions to retain the pivot rod 182 within a channel 132 in the layer 126. The channel 132 is further defined by the wall 129, similar to channel 128. The sleeve 184 located/retained in channel and sandwiched between core portions defining the channel 132 such that the sleeve 184 retains the rod 182 on the layer portion 126.

Further, the rod 182 is received within the sleeve 184 in frictional engagement such that the sleeve 184 allows the visor 120 to pivot on the rod 182 in a controlled manner such that the visor 120 will not move without the application of a predefined amount of force and the visor 120 will maintain its set position under normal operating conditions of the vehicle. Detents it in the stowed position which holds visor 120 in secured position.

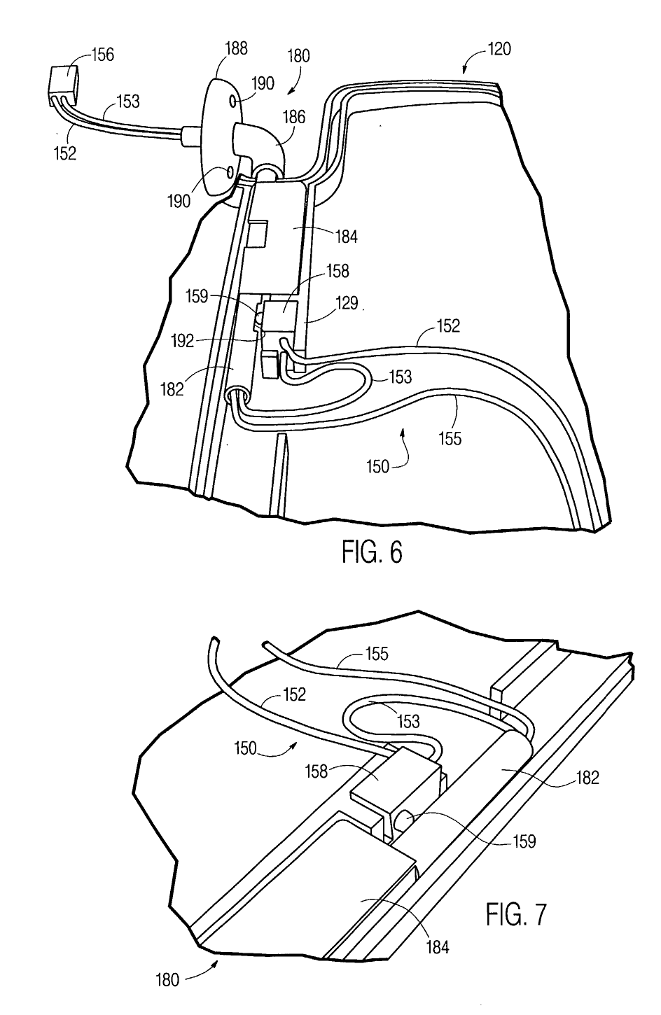

Referring to FIG. 3 through FIG. 7. Since the compass unit 20, according to one exemplary embodiment, is intended to indicate the direction heading of the vehicle, the compass unit 20 and compass display 10 are designed to function only when the visor 120 is in the stored position, which preferably aligns the compass unit 20 with the longitudinal direction of the vehicle 110 as shown in FIG. 1. This avoids the significant costs associated with including automatic calibration hardware. Alternatively, a position sensor can be coupled to visor 120 and configured to detect the position of visor 120. Compass unit 20 can then compensate the directional signal for changes in position of visor 120. One suitable system is disclosed in U.S. application Ser. No. 09/651,521 entitled “Method and Apparatus to Maintain Compass Heading with a Moveable Sensor Mounting” to Thomas R. Olson, filed Aug. 30, 2000, which is herein incorporated by reference.

The wiring harness 150 includes the wires 152, 153 and 155 and the switch 158 for deactivating the compass unit 20 and compass display 10 when the visor 120 is moved from the stowed position.

The switch 158 is positioned and aligned within partial layer 126 of the visor core 124 in a channel 128 defined by a wall 129. The switch 158 includes a follower contact 159 which is preferably spring loaded and biased in an outward direction from the switch 158 for contact with a portion of a pivot rod 182 of the pivot rod assembly 180.

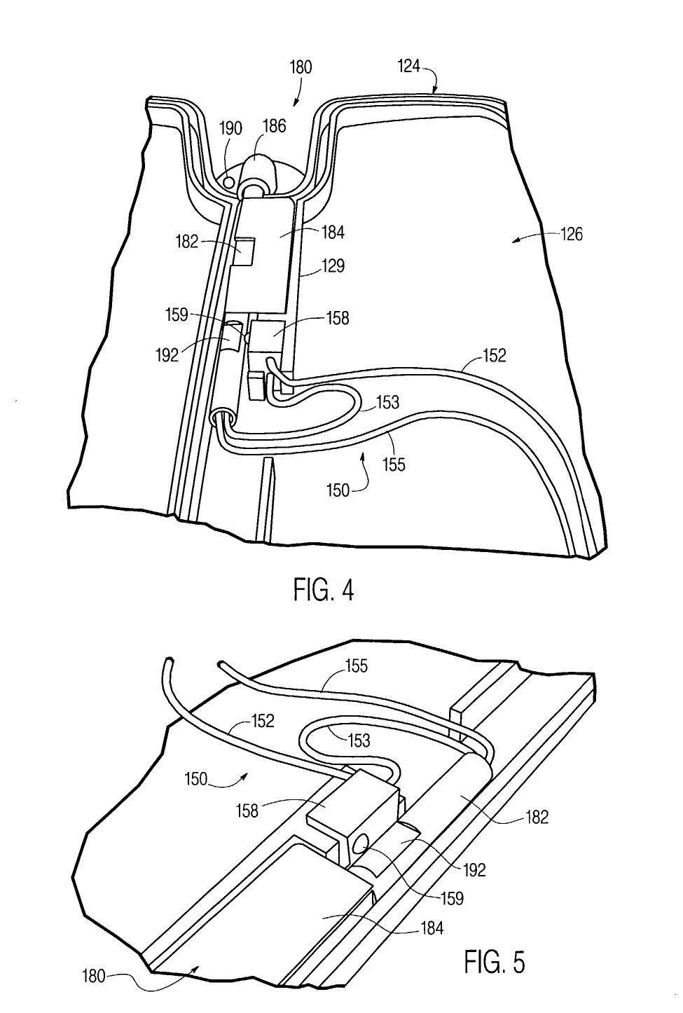

The sleeve 184 and pivot rod 182 are located proximate the switch 158 such that the switch 158 is aligned with a flat 192 on the pivot rod 182 as shown in FIG. 4 through FIG. 7. The flat 192 of the pivot rod 182 is designed to co-act with the follower contact 159 of the switch 158. When the visor 120 is rotated from the stowed position on the pivot rod 182 which remains stationary, the follower contact 159 of the switch 158 aligns with the flat 192 of the pivot rod 182 allowing the follower contact 159 to be biased outward from the switch 158 thereby opening the switch 158 and turning off the compass unit 20 and the compass display 10. This feature prevents the necessity to have to recalibrate the compass unit 20 and compass display 10 each time the visor 120 is moved from the stowed position.

It should be understood by a person of ordinary skill in the art that while the switch 158 is shown as co-acting with the periphery of the pivot rod 182 to switch the power to the compass unit 20, it is possible that any other known or appropriate switch or power interruption device may be used for turning off the compass unit 20 and compass display 10 when the visor 120 is moved from the stowed position.

Further, it is possible to provide a separate compass on/off switch (not shown) that is not automatically activated by the movement of the visor 120. For example, a switch can be provided separately for example on the face of the visor 120 that a user can manually activate. The same switch or a second switch can be provided as a mode switch to switch between various modes of the compass display device.

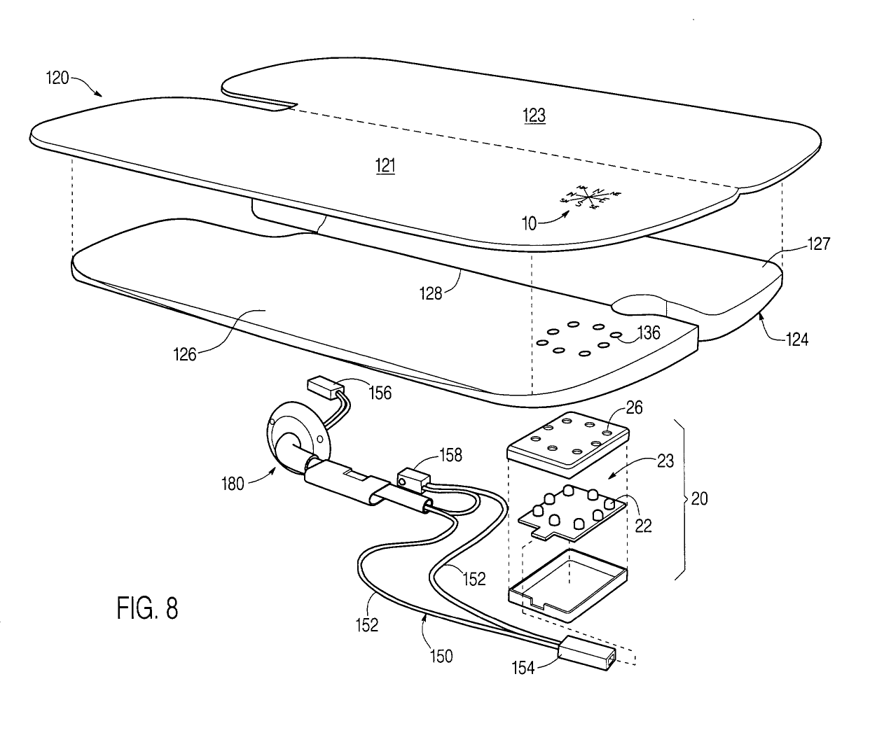

Referring to FIG. 8, the compass assembly 20 further includes a plurality of lights 22 arranged to correspond with the referents of the compass unit 20. While the present invention preferably includes eight lights 22 in the plurality of lights, it should be understood by a person of ordinary skill in the art that it is possible that the compass unit 20 of the present invention include a single light 22 or any number of lights depending upon the resolution desired in the referents of the compass unit 20. Each light 22 of the plurality of lights 23 align with a respective hole 26 in a housing 24 of the compass unit 20. Similarly, each light 22 of the plurality of lights 23 also preferably aligns with a respective hole 136 of the visor core 124. Accordingly, when the visor 120 is in the stowed position and a light 22 of the plurality of lights 23 is powered to indicate the heading direction by having the compass system energize the light 22, the occupant of the vehicle 110 can perceive that the light 22 is lit.

Referring to FIG. 6, the pivot rod assembly 180 further includes an elbow 186 connected to an end of the pivot rod 182. A mount or connector 188 is connected to the elbow 186 using any known or appropriate connecting means such as glue, staking, fasteners, threaded connectors or the like as may be appropriate for connecting the elbow 186 to the pivot rod 182 and maintain the relative movement for proper functioning of the visor 120. The other end of the elbow 186 may be fixedly or permanently connected to the mount 188 but is preferably pivotally connected thereto. The mount 188 includes holes 190 for mounting the visor 120 to the interior of the vehicle 110 in a manner well known in the art but may be attached using any known or appropriate connector design. The connector 188 has the wires 152 and 153 passing through the elbow 186 and extending therefrom to the connector 156.

The compass unit 20 has power supplied to it by a wiring harness 150 or any other known or appropriate device for supplying an appropriate level and condition of power to the compass unit 20. The wiring harness 150 includes wires 152 and wire 153 and a connector 154 to connect the wires 152 of the wiring harness 150 to the compass unit 20. The wires 152 and the wire 153 are routed in any known or appropriate manner to pass within the visor 120 and through the pivot rod 182 of the pivot rod assembly 180 to a second connector 156 for connection of the compass unit 20 to the vehicle's power supply and CPU (not shown). The wiring harness 150 connects with the vehicle's power system to supply the level and condition of power needed for the compass unit 20 and the compass display 10 to function properly.

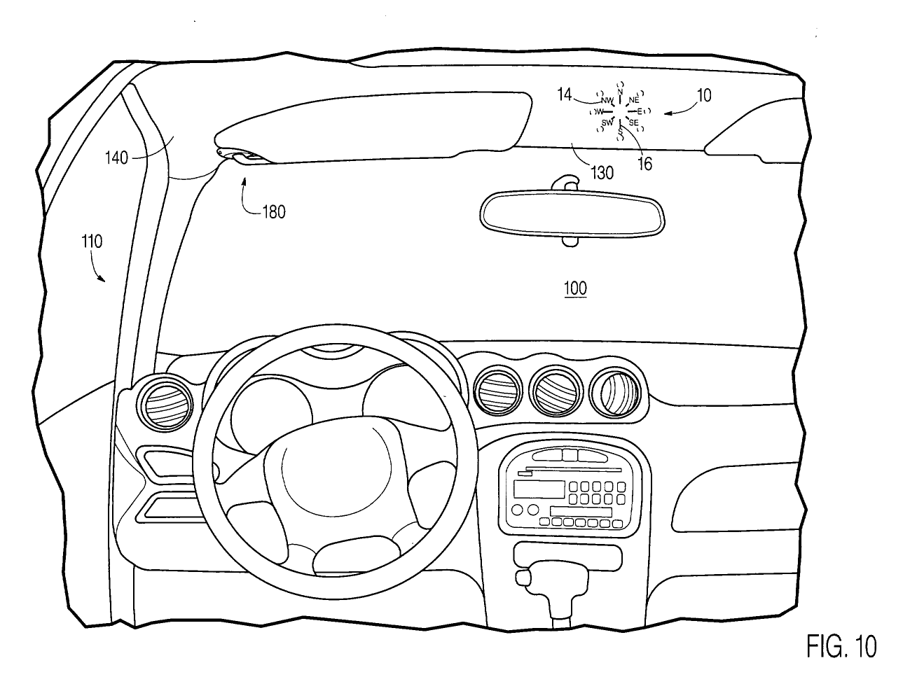

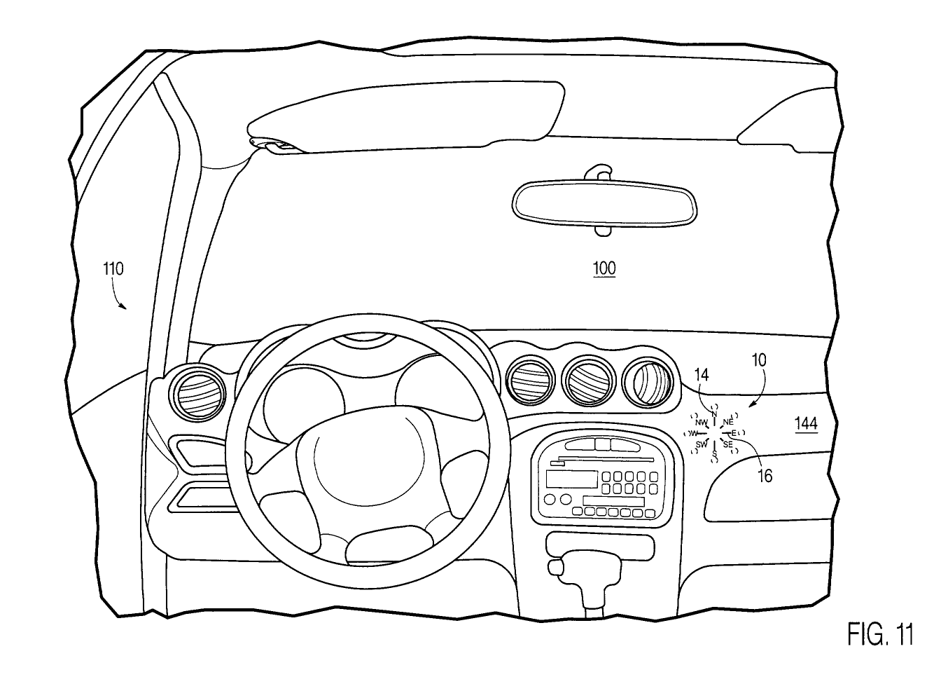

In an alternate embodiment, as shown in FIG. 10, the compass display 10 and the compass unit 20 are incorporated in the headliner 140 of the vehicle 110 such that the compass display 10 can still be perceived by an occupant in the passenger compartment 100. In the embodiment of FIG. 10, the finish cover 130 preferably forms the interior finishing of the headliner 140. In a further embodiment of the present invention, as shown in FIG. 11, the compass display 10 is incorporated in a dash board 144 in the passenger compartment 100 of the vehicle 110, such that an occupant of the vehicle and preferably the driver may view the compass display 10. In all of the embodiments shown, the compass display 10 preferably includes a set of compass referent directions 14 printed or screened on the respective materials which comprises either the first surface of the compass display 10 such as the housing 24 or first layer 126 of the visor 120 or on the finish cover 130 of the visor 120, headliner 140 or dash board 144, respectively. In the embodiments shown, the compass referent directions 14 preferably include eight (8) referent directions including north, northeast, east, southeast, south, southwest, west, and northwest. It is should be understood that it is possible for the referent directions 14 to include only one referent corresponding to a direction or as many referents as desired depending upon the desired resolution for the compass display 10 and the number of lights 22. Further, it should be understood that while eight (8) referent directions 14 and respective referent lines 16 are shown in the embodiments described herein and eight (8) corresponding lights 22 are shown, it is possible for the compass display 10 to include fewer or greater referent directions than lights 22.

Referring to FIGS. 10 and 11, the visor 120 of the preferred embodiment further preferably includes a surface covering or finish cover 130 that covers the exterior side of the layer 124 to provide alternative aesthetic trim surfaces, if desired. Preferably, the visor 120 is provided with a finish cover 130 and the occupant of the vehicle 110 can still perceive the light 22 as being lit from within passenger compartment of the vehicle during normal operating conditions since such finish cover 130 is preferably light transmissive. The cover 130 is preferably made from any known or appropriate fabric material suitable to allow an illuminated light source such as light 22 to be viewed through the cover 30 but may be made using any known and appropriate material such as fabric, cloth, vinyl, plastic, polymeric, leather, etc. Alternatively, a finish cover 130 that is not sufficiently light transmissive can be selected and a hole (not shown) is provided in the finish cover 130 for allowing the light 22 aligned with respect to such hole to be perceived by the occupant of the vehicle 110. If the finish cover 130 is made from an opaque or relatively low light-transmissive material such as plastic, polymeric, leather or a “backed” or “tight-weave” fabric, the hole or other element maybe provided in the finish cover 130 to allow light emitted from a light 22 to be perceived on the first side 121 of the visor 120.

It is understood that while the drawings and specific examples provided describe in detail the preferred embodiments of the present invention, they only serve an illustrative purpose. The apparatus of the invention is not limited to the precise details and conditions disclosed. For example, the compass display can be adapted or configured for compatibility with other finish coverings of different materials, to be located in other types of vehicles and also to satisfy the design standards of a wide variety of automobile manufacturers. A further alternative example contemplated hereby would be to include a template beneath the finish covering as an alternative to the visor core. The template could be a separate piece that is snap connected to the finish cover and has a patterned hole or other cutout such as in the shape of a letter. Additionally, it is possible to have shaped LEDs in the form of letters to represent the referent directions of the compass.

Further, although particular shapes and relative dimensions have been shown, various other shapes, geometry and dimensions could be utilized for the various components. Other substitutions, modifications, changes and omissions may be made in the design, operating conditions and method of manufacturing the apparatus of the preferred embodiments without departing from the spirit of the invention as expressed in the appended claims.

What is claimed is:

1. A compass display for displaying a heading direction, the compass display capable of communicating with a compass system, the compass display comprising:
a first surface having a set of compass referents corresponding to geographical directions; and
a plurality of light sources located with respect to the first surface, a light source of the plurality of light sources corresponds to a respective referent of the set of compass referents of the compass display and wherein a directional signal generated by the compass system communicates with at least one light source of the plurality of light sources to display the heading direction.

2. The compass display of claim 1 wherein the compass display further comprises a surface covering comprising the first surface and the set of compass referents are located on the surface covering

3. The compass display of claim 2 wherein the surface covering comprises a plurality of holes corresponding to the plurality of light sources.

4. The compass display of claim 2 wherein the surface covering comprises a fabric material and further wherein the compass referents are located on the fabric material.

5. The compass display of claim 1 wherein the compass display further comprises a housing having a plurality of holes therein, the housing comprising the first surface and having a plurality of holes wherein a light source of the plurality of light sources corresponds to a hole of the plurality of holes.

6. The compass display of claim 2 wherein each light source of the plurality of light sources comprises a light emitting diode.

7. The compass display of claim 1 further comprising a visor having a first side and wherein the first surface of the compass display comprises the first side of the visor.

8. The compass display of claim 2 further comprising a visor having a first side and wherein the surface covering of the compass display comprises the first side of the visor.

9. The compass display of claim 7 wherein the visor is for use in a passenger compartment of a vehicle, the visor being movable from a stowed position in which the compass display is viewable within the passenger compartment, the compass display further comprising a switch for turning off the compass display when the visor is moved from the stowed position.

10. The compass display of claim 7 wherein the compass display further comprises a housing, the plurality of lights extending with respect to the housing and further wherein the visor comprises a core having a first core portion having a first side, a second side and a plurality of holes therein, the housing positioned on the second side of the first core portion of the visor such that the plurality of lights correspond to the plurality of holes in the first core portion and the plurality of lights can be seen from the first side of the first core portion of the visor.

11. The compass display of claim 10 wherein the core further comprises a second core portion connected to first core portion and the housing is positioned between the first core portion and the second core portion.

12. The compass display of claim 8 wherein the compass display further comprises a housing, the plurality of lights extending with respect to the housing and further wherein the visor comprises a core having a first core portion having a first side, a second side and a plurality of holes therein, the housing positioned on the second side of the first core portion of the visor such that the plurality of lights correspond to the plurality of holes in the first core portion, the surface covering positioned to cover at least the first side of the first core portion of the visor.

13. The compass display of claim 12 wherein the core further comprises a second core portion connected to first core portion and the housing is positioned between the first core portion and the second core portion and the surface covering covers both the first core portion and the second core portion.

14. The compass display of claim 7 wherein the set of compass referents comprises directional indicia located on the first side of the visor, the directional indicia including a first indicia representing a North geographic direction, a second indicia representing a South geographic direction, a third indicia representing an East geographic direction and a fourth indicia representing a West geographic direction.

15. The compass display of claim 8 wherein the set of compass referents comprises directional indicia located on the surface covering of the visor, the directional indicia including a first indicia representing a North geographic direction, a second indicia representing a South geographic direction, a third indicia representing an East geographic direction and a fourth indicia representing a West geographic direction.

16. The compass display of claim 2 further comprising a headliner for a vehicle, the headliner having a first surface and wherein the surface covering of the compass display comprises the first surface of the headliner.

17. The compass display of claim 2 further comprising an interior trim surface located within a passenger compartment of a vehicle, and wherein the surface covering of the compass display comprises the interior trim surface.

18. The compass display of claim 17 wherein the interior trim surface is a trim cover for an A pillar in the vehicle.

19. The compass display of claim 17 wherein the interior trim surface is a trim cover for a dashboard.

20. A compass display for use in a visor in a vehicle, the compass display for displaying a heading direction of the vehicle, the compass display having a center point and being capable of communicating with a compass system, the compass system generating a directional signal corresponding to the heading direction of the vehicle, the compass display comprising:
a first surface having a first side and a second side, the first surface located on the visor to be viewed by an occupant of the vehicle when the visor is in a stowed position, the first surface having a set of compass referents corresponding to geographical directions; and
a light source located with respect on the second side of the first surface and arranged to correspond to a first respective referent of the set of compass referents and wherein the directional signal generated by the compass system communicates with the light source to energize the light source to display the heading direction of the vehicle.

21. The compass display of claim 20 wherein the first surface comprises a hole extending from the first side to the second side and the light source is aligned with the hole.

22. The compass display of claim 20 further comprising a surface covering located on and covering the first side of the first surface of the visor, the surface covering being viewable when the visor is located in a stowed position, the light source being viewable through the surface covering when the compass system energizes the light source to display the heading direction of the vehicle.

23. The compass display of claim 21 further comprising a surface covering located on and covering the first side of the first surface of the visor, the surface covering being viewable when the visor is located in a stowed position, the surface covering having a hole aligned with the hold in the first surface of the visor such that the light source is viewable through the surface covering when the compass system energizes the light source to display the heading direction of the vehicle.

24. The compass display of claim 20 wherein the visor is movable from the stowed position, the compass display further comprising a switch for turning off the compass display when the visor is moved from the stowed position.

25. The compass display of claim 24 wherein the visor of the compass display further comprises a pivot rod assembly for connecting the visor to the passenger compartment of the vehicle, the pivot rod assembly including a pivot rod having a first end disposed in the visor and a second end disposed external the visor, the second end of the pivot rod for pivotally mounting the visor to the vehicle, the pivot rod having a circular cross section having a first flat surface, the flat surface communicating with the switch when the visor is moved from the stowed position.

26. The compass display of claim 20 wherein each light source of the plurality of light sources comprises a light emitting diode.

27. The compass display of claim 20 wherein the compass display further comprises a housing, the plurality of lights extending with respect to the housing and further wherein the visor comprises a core layer portion having a first core portion having a first side, a second side and a plurality of holes therein, the housing positioned on the second side of the first core portion of the visor such that the plurality of lights correspond to the plurality of holes in the first core portion, the surface covering positioned to cover at least the first side of the first core portion of the visor.

28. The compass display of claim 27 wherein the core further comprises a second core portion connected to first core portion and the housing is positioned between the first core portion and the second core portion and the surface covering covers both the first core portion and the second core portion.

29. A visor for use in a vehicle, comprising
a compass display for displaying a heading direction of the vehicle, the compass display including a set of compass referents, the compass display capable of communicating with a compass system generating a directional signal corresponding to the heading direction of the vehicle;
a first surface having a first side and a second side, the first surface located in the vehicle to be viewed by an occupant of the vehicle when the visor is in a stowed position, the first surface having a set of compass referents corresponding to geographical directions; and
a light source located with respect on the second side of the first surface and arranged to correspond to a first respective referent of the set of compass referents and wherein the directional signal generated by the compass system communicates with the light source to energize the light source to display the heading direction of the vehicle.

30. The visor of claim 29 wherein the first surface comprises a hole extending from the first side to the second side and the light source is aligned with the hole.

31. The visor of claim 29 further comprising a surface covering located on and covering the first side of the first surface of the visor, the surface covering being viewable when the visor is located in a stowed position, the light source being viewable through the surface covering when the compass system energizes the light source to display the heading direction of the vehicle.

32. The visor of claim 30 further comprising a surface covering located on and covering the first side of the first surface of the visor, the surface covering being viewable when the visor is located in a stowed position, the surface covering having a hole aligned with the hold in the first surface of the visor such that the light source is viewable through the surface covering when the compass system energizes the light source to display the heading direction of the vehicle.

33. The visor of claim 29 wherein the visor is movable from the stowed position, the compass display further comprising a switch for turning off the compass display when the visor is moved from the stowed position.

34. The visor of claim 33 further comprising a pivot rod assembly for connecting the visor to the passenger compartment of the vehicle, the pivot rod assembly including a pivot rod having a first end disposed in the visor and a second end disposed external the visor, the second end of the pivot rod for pivotally mounting the visor to the vehicle, the pivot rod having a circular cross section having a first flat surface, the flat surface communicating with the switch when the visor is moved from the stowed position.

35. The visor of claim 29 wherein each light source of the plurality of light sources comprises a light emitting diode.

36. The visor of claim 29 wherein the compass display comprises a housing, the plurality of lights extending with respect to the housing and further wherein the visor comprises a core layer portion having a first core portion having a first side, a second side and a plurality of holes therein, the housing positioned on the second side of the first core portion of the visor such that the plurality of lights correspond to the plurality of holes in the first core portion, the surface covering positioned to cover at least the first side of the first core portion of the visor.

37. The compass display of claim 36 wherein the core further comprises a second core portion connected to first core portion and the housing is positioned between the first core portion and the second core portion and the surface covering covers both the first core portion and the second core portion.
